(19) United States
(12) Patent Application Publication
(10) Pub. No.: US 2003/0088427 A1
(43) Pub. Date: May 8, 2003

(54) Technique for effective management of schedules of time-sensitive events from different sources

(76) Inventors: Nicholas J. Elsey, West Linn, OR (US); Timothy A. Timmins, Tigard, OR (US)

Correspondence Address: Alex L. Yip, Kaye Scholer LLP, 425 Park Avenue, New York, NY, 10022, US

(21) Appl. No.: 10/003,930

(22) Filed: Nov. 2, 2001

(51) Int. Cl. G06F 17/60

(52) U.S. Cl. 705/1

(57) ABSTRACT

A user of a personal information manager (PIM) may conveniently input an appointment time in the PIM according to a time zone (e.g., Eastern time zone) different from the default time zone (e.g., Pacific time zone) on which the PIM operates. When the appointment data including the appointment time is synchronized into a database, in accordance with an inventive time-shift approach, the appointment time is initially accepted into the database, and then corrected based on a time range specified by the user, appointments within which are time-shifted from the default time zone to another time zone also specified by the user. In accordance with a second, inventive time-zone qualifier approach, the user when entering the appointment time in the PIM also provides a time-zone qualifier specifying a time zone different from the default time zone. Based on such a qualifier, in a data synchronization, an administrator of the database corrects the appointment time in the PIM to reflect the specified time zone before it incorporates the appointment time into the database.

### FIELD OF THE INVENTION

The invention relates to a data management technique, and more particularly to a technique for synchronizing schedules of time-sensitive events, e.g., meeting appointments, between different sources.

### BACKGROUND OF THE INVENTION

The concept of “time” in relation to travel is always fascinating, which was expounded by Albert Einstein in his revolutionary theory of relativity, and is integral to the plot of such classics as Jules Verne's “Around the World in Eighty Days.” In a mundane example, when one travels from California to New York, he/she needs to adjust his/her California time (e.g., Pacific Standard Time (PST)) ahead by three hours to keep up with the New York time (e.g., Eastern Standard Time (EST)). This stems from the artificial division of the world into twenty-four time zones, and California is in a GMT-08:00 time zone while New York is in a GMT-05:00 time zone. That is, the PST corresponding to the GMT-08:00 time zone lags the Greenwich Mean Time (GMT) by eight hours, and is said to be −8 hours offset the GMT. On the other hand, the EST corresponding to the GMT-05:00 time zone lags the GMT by five hours, and is said to be −5 hours offset the GMT. As a result, the travel from California to New York necessitates a time-shift of 3 hours ahead (i.e., (−5 hours offset)-(−8 hours offset)).

Use of personal information managers (PIMs) to organize appointment data in a calendar is ubiquitous. However, a problem may arise when a user of one such PIM, which typically is set to operate on a default time zone, needs to synchronize the PIM calendar data with another system managing the user's appointment data. Specifically, let's say the user is based in California. Accordingly, the default time zone of the user's PIM is set to the Pacific time zone. When such a PIM user sets up an appointment to meet someone, say, in New York at 4 p.m. EST on a future date, knowing that he/she will physically be in New York at that time, the user enters the appointment time simply as “4 p.m” in the PIM calendar, ignoring the fact that the default time zone of the PIM is set to the Pacific time zone. Let's also say the user is an employee of a company, and regularly synchronizes his/her PIM calendar data with a company system which manages appointment data of its employees. In that case, recognizing that the default time zone of the user's PIM is the Pacific time zone, the company system creates, as a result of the PIM data synchronization, an appointment record of the aforementioned meeting as a 4 p.m. PST meeting, as opposed to the actual 4 p.m. EST meeting. Thus, for example, based on such an erroneous appointment record, an assistant of the user in the company would incorrectly schedule events around the meeting for the user, or provide an inaccurate meeting reminder to the user, which is undesirable.

A similar problem is anticipated where a user is a subscriber to a personalized information service where his/her PIM calendar is regularly synchronized with a database of the service provider, and an operator provides services to the user based on the user appointment records created in the database as a result of such a data synchronization.

### SUMMARY OF THE INVENTION

The invention, however, solves the above-identified problem. When information in a selected data item (e.g., an appointment record) in a user's PIM, operating on a default time zone, is shared with a second source (e.g., the database in the aforementioned personalized information service), a time range and a time zone applicable to the time range are elicited from the user, in accordance with the invention. Times associated with data items in the PIM which fall within such a time range will not be considered according to the default time zone in the second source. Rather, they will be considered according to the applicable time zone which may be different from the default time zone. As such, if the time associated with the selected data item falls within the time range, the associated time is stored in the second source according to the applicable time zone, along with the shared information.

In a second embodiment of the invention, the user may include a time-zone qualifier in the data item to indicate an intended time zone to which the time associated with the data item refers, and which may be different from the default time zone. For example, the time-zone qualifier may contain an abbreviation of the intended time zone. Thus, in this second embodiment, the time associated with the data item including a time-zone qualifier is stored in the second source according to the intended time zone indicated thereby, along with the shared information.

### BRIEF DESCRIPTION OF THE DRAWING

Further objects, features and advantages of the invention will become apparent from the following detailed description taken in conjunction with the accompanying drawing showing illustrative embodiments of the invention, in which:

FIG. 1 illustrates a communications system including information/call centers in accordance with the invention;

FIGS. 2A and 2B are block diagrams of components of the communications system of FIG. 1;

FIG. 3 illustrates a Login graphical user interface (GUI) for providing a personalized information service;

FIG. 4 illustrates a Home GUI for providing the personalized information service;

FIG. 5 is a block diagram of a computer system for accessing the communications system of FIG. 1.

FIG. 6 illustrates a Home page presented by the communications system to the computer system;

FIG. 7 illustrates a Time-Shift Configuration page used in a first embodiment of the invention;

FIG. 8 illustrates a daily calendar view page in the first embodiment;

FIG. 9 illustrates an appointment record in a personal information manager (PIM);

FIG. 10 illustrates a process in a second embodiment of the invention for synchronizing data from the PIM into a database in the communications system of FIG. 1; and

FIG. 11 illustrates a daily calendar view page in the second embodiment.

### DETAILED DESCRIPTION

The invention is directed to a technique for management of schedules of time-sensitive events, e.g., meetings, which may occur in different time zones. It is common to use personal information managers (PIMs) to organize appointment data in a calendar. Well known PIMs include, e.g., hand-held devices such as personal digital assistants (PDAs) and wireless communicators; and computer devices such as notebook, laptop and desktop computers running software applications such as Microsoft Outlook, Outlook Express, Goldmine, Symantec Act!, Lotus Organizer and Lotus Notes. Other PIMs may include proprietary PIM systems and applications. In this illustrative embodiment, a PIM user subscribes to a personalized information service, and from time to time synchronizes his/her PIM calendar with a database of the service provider.

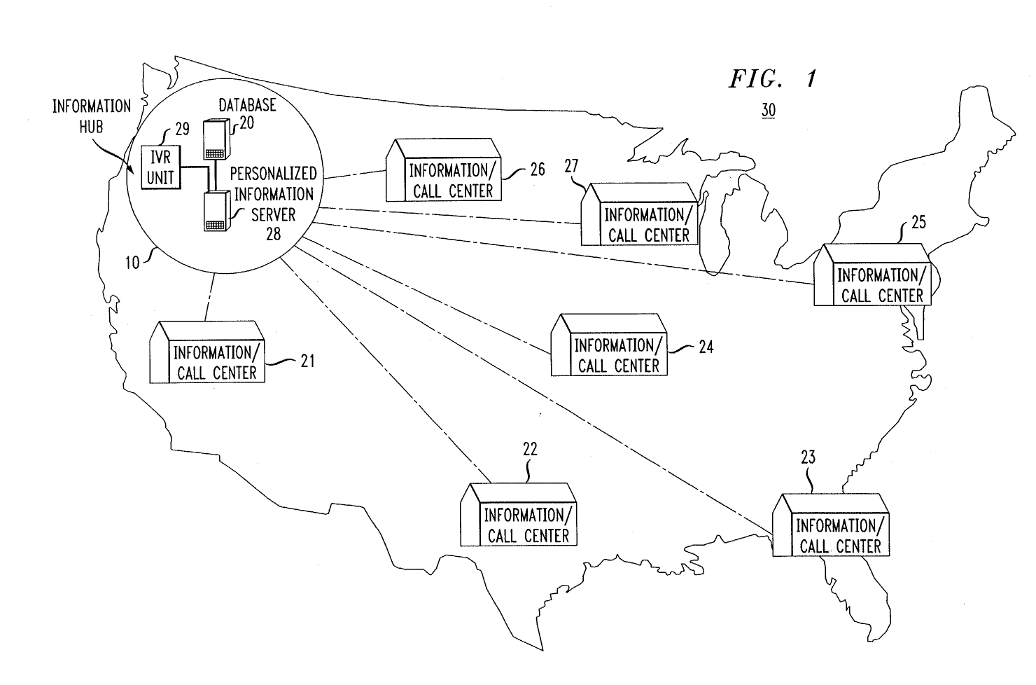

FIG. 1 illustrates a system embodying the principles of the invention providing the personalized information service, which includes wide area network (WAN) 30 covering an extensive area. WAN 30 can be an Internet-based network such as the World Wide Web or a private intranet based network. WAN 30 connects operators dispersed throughout a wide coverage area in information/call centers 21 through 27. It should be noted that the term “operators” used herein broadly encompasses entities that are capable of providing assistance in a telecommunication environment, including without limitation human operators, voice response/recognition capabilities, web-enabled operator services, and other automated and electronic access. Each of information/call centers 21 through 27 covers one or more regional coverage areas. One or more information hubs 10 are also included in WAN 30. An information hub 10 includes one or more personalized information servers 28 which are accessible by the operators in the system, and one or more databases 20 in which subscribers' information, appointments and other folders (e.g., contacts folders for storing contacts information) are stored and maintained. Such information and folders may also be stored locally at one or more of the information/call centers.

A user of the personalized information service may want to create multiple appointments folders for different purposes. For example, they may include a personal appointments folder containing personal appointment data, and a business appointments folder containing business appointment data. With the personalized information service, an appointments folder may be created and maintained (1) through the Internet or other network or communications means directly, (2) through an operator indirectly, and/or (3) using a PIM. In case (3), by running a synchronization engine, the user may update any appointment data which has been changed (added, edited or deleted) in a PIM data source in the corresponding appointments folder, and vice versa.

In case (2), the user accesses an appointments folder through communications with an operator at an information/call center via telecommunication media, e.g., wireless telephone, wireline telephone, voice over Internet protocol (VoIP), PDA, VPN, etc. The operator, as explained in more detail below, is generally provided with web browsing capabilities, telephone facilities as well as fully-featured operator user interface applications which facilitate the searching, retrieval and administering of database 20 through server 28. It is well understood that operators generally receive and respond to requests for information and communications services.

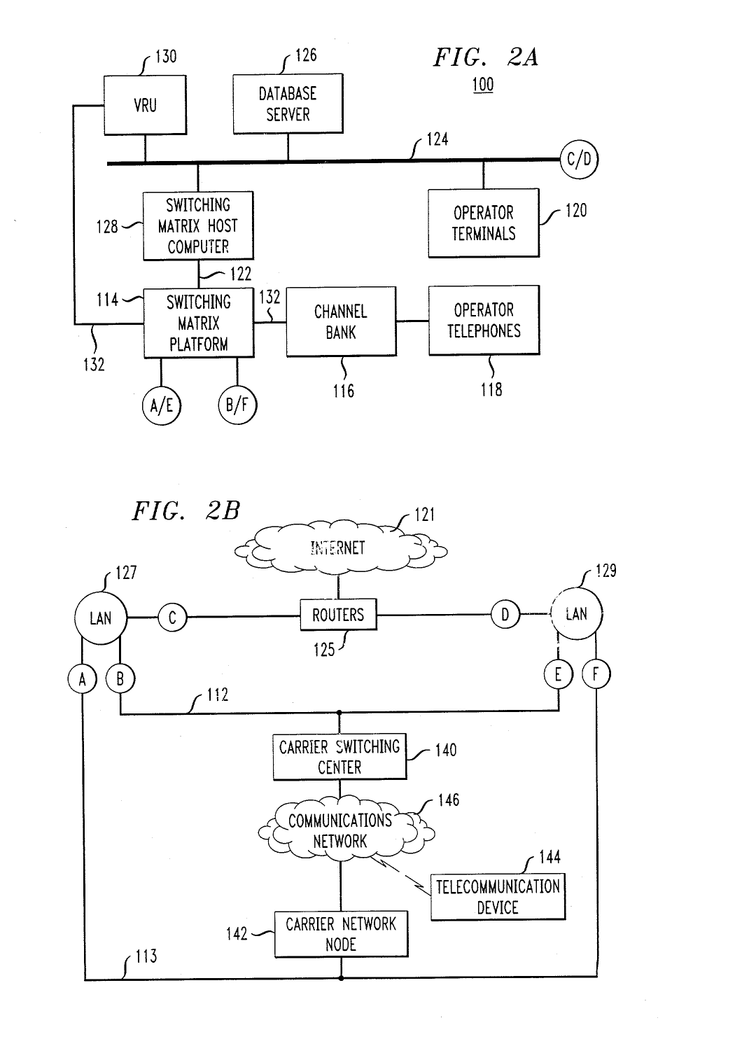

Referring to FIGS. 2A and 2B, information/call center 100 (which generically represents one of aforementioned information/call centers 21 through 27) is attended by operators, which includes switching matrix platform 114 connected to one or more external T1 voice connections 112. Switching matrix platform 114 is also connected via T1 communication links 132 to channel bank 116 for coupling to operator telephones 118.

Each operator is equipped with a terminal 120 that includes a monitor, mouse and keyboard with associated dialing pad. The operator terminals are coupled over data network 124 to database server 126, allowing an operator to access the data in database server 126 through operator terminals 120. Database server 126 contains, among other things, public directory information.

Data network 124 further connects to voice response unit (VRU) 130, and switching matrix host computer 128 (also known as a PBX host), which in turn is connected to switching matrix platform 114 by data link 122. Data network 124 includes, but is not limited to, local area network (LAN) 127, best seen in FIG. 2B. LAN 127 may connect to other similar remote LANs 129 to form WAN 30 in FIG. 1. LANs 127 and 129 are connected to one another and to Internet 121 via routers 125.

A user's telephone, computer, PDA or other telecommunication device 144 communicates via communications network 146 which is connected to carrier network node 142 and carrier switching center 140. T1 voice connections 112, or voice links, provide connection between the information/call center's switching matrix platform 114 and the carrier's switching center 140, through which incoming information service calls are received. T1 voice connections 112 further provide connection to the carrier network over which outgoing calls are placed (which network may be different than that used for incoming calls). Similarly, T1 data connections 113, or data links, provide a signaling connection between the information/call center's node (not shown) and carrier network node 142, through which incoming and outgoing signaling messages are transported. The information/call center node is contained within switching matrix platform 114, but one with skill in the art will appreciate that the information/call center node could also be a physically distinct component. If the outgoing call is being placed over a different network than that on which the incoming call was received, a second data connection to the outgoing network will be established.

The operation of switching matrix platform 114 is governed by computer-readable instructions stored and executed on switch matrix host computer 128. VRU 130 is connected via data network 124 to switching matrix host 128 (to which it acts as a slave processor) and via one or more T1 spans to switching matrix platform 114. Each VRU 130 when more than one is employed in information/call center 100, connects to switching matrix platform 114 via a separate voice server link. VRU 130 is employed to play the constantly repeated parts of an operator's speech, namely, the various greetings and signoffs (or closings), and the caller's desired telephone number where requested. At appropriate stages in a call progression, switch matrix host computer 128 initiates a voice path connection between VRU 130 and switching matrix platform 114 such that the user, or the user and the operator, are able to hear whatever pre-recorded speech is played on that connection by VRU 130. Computer 128 then instructs VRU 130, via data network 124, what type of message to play, and passes data parameters that enable VRU 130 to locate the message appropriate to the call state. VRU 130 may also contain a voice recognition system for receiving verbal input from a party connected to the VRU.

Database server 126 enables the operator to search not just by name and address, but also by type of goods/services and/or geographical region, or by any other attribute in the caller record, including phone number.

Users of a particular telephone carrier or company may dial, speak or otherwise communicate the access digits, access codes or retail numbers, or input an address or a URL established for information assistance by that company. The instant example assumes that the user dials, e.g., “411,” “*555,” “555-1212,” “1-800-555-1212,” “00,” or other designated access numbers. The participating telephone company's own switching system will then reroute the call to information/call center 100 (via a T1 channel), where it appears as an incoming call.

Automatic call distribution (ACD) logic is used to queue (if necessary) and distribute calls to operators in the order in which they are received, and such that the call traffic is distributed evenly among the operators. In other embodiments, other distribution logic schemes are utilized, such as skills-based routing or a priority scheme for preferred callers. The queue is maintained by switching matrix host 128.

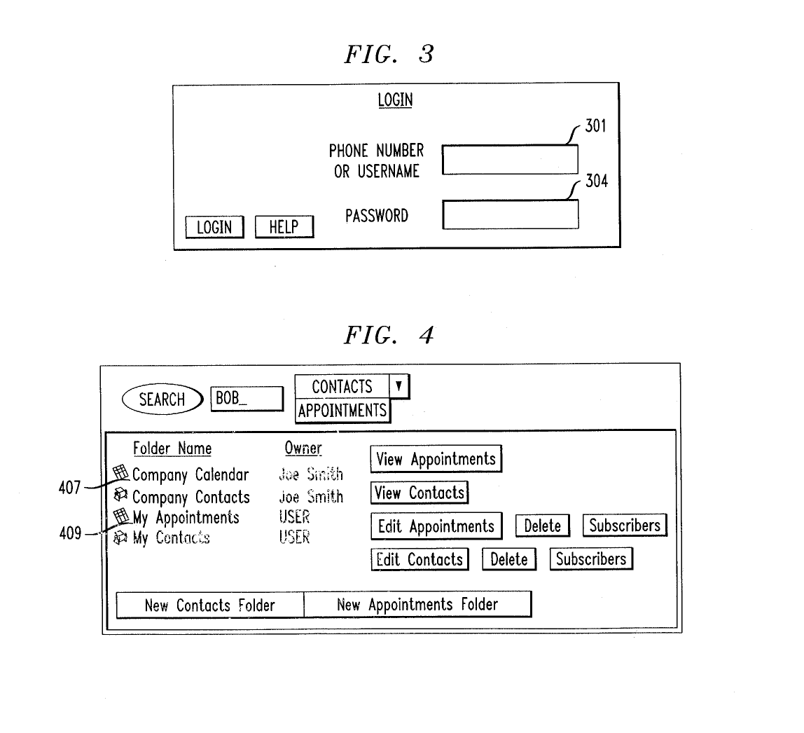

As mentioned before, a user may create, maintain or access an appointments folder via the Internet or other network or communications means, or through an operator who in turn may create, maintain or access the folder on behalf of the user. Without loss of generality, the user in this instance wants to access an appointments folder through an operator. To that end, the user uses telecommunication device 144, e.g., a wireless phone, to call an operator at a designated access number. Let's say the call is routed to information/call center 100 where an operator attends to the call. After the user communicates to the operator his/her needs, the operator at terminal 120 accesses personalized information server 28 through WAN 30 (or alternatively Internet 121). In response, server 28 presents on terminal 120 a Login graphical user interface (GUI), which is illustrated in FIG. 3. As shown in FIG. 3, the operator is prompted to enter the user's phone number or username to identify the user, and a password to verify that the user is authorized to access the personalized information service. It will be appreciated that other user identifying information, e.g., a personal identification number (PIN), his/her mother's maiden name, etc. may be used for verification purposes as well.

It should be noted at this point that the user identification and password are established beforehand through a registration process. For example, to join the personalized information service, the user can call an operator at the designated access number. As part of the registration, the operator enters at a user data web page on server 28 the user identifying information including username, password, and telephone number of the particular telecommunication device, e.g., wireless phone in this instance, which the user would use to call the service in the future. It is particularly advantageous to use such a phone number (also known as a mobile directory number (MDN) in the case of a wireless phone number) to identify the user since the calling number would be automatically captured at information/call center 100 when the user calls. Specifically, platform 114 in center 100 in a well known manner derives, from the call set-up signals associated with the user's call, the user's phone number from which the call originates, also known as the automatic number identification (ANI).

Thus, referring to FIG. 3, the ANI of the user is automatically provided in entry 301 by platform 114, thereby obviating the need of the operator's eliciting from the user, and entering, the required phone number or username. (In the event that such an ANI is not automatically available or where the user is accessing the subject service from an unknown point, the user may supply via voice or other input, with or without prompting, the necessary identifying information.) At entry 304, the operator enters the password provided by the user to complete the login process. The login information is then transmitted to server 28, where it checks the aforementioned user data web page to verify the received ANI and password. After they are verified, server 28 identifies from the user data web page all of the folders including appointments folders associated with the received ANI, and any user's access rights thereto. Server 28 then presents to terminal 120 a Home GUI, listing all such appointments folders. FIG. 4 illustrates the Home GUI, which lists, among others, appointments folders 407 and 409 designated “Company Calendar” and “My Appointments,” respectively. The operator can then access the desired appointments folder, and manage the appointment data in the desired folder for the user, subject to the user's access rights. The operator may also direct the call to interactive voice response (IVR) unit 29 connected to server 28 in FIG. 1 to allow the user to hear selected appointments.

In addition, server 28 may be programmed to send a reminder notification to a user prior to his/her appointment. Thus, the notification may be automatic or selected by the user as an option. The notification is provided by server 28 a period before the appointment, where the length of the period may be predetermined or selected by the user, or varies with the subject, category and/or information content of the appointment record provided by the user.

The reminder notification may be communicated to the user via telephone, SMS, email, facsimile, etc. For example, server 28 may cause IVR unit 29 to call the user's wireless phone number to verbally remind the user of an upcoming appointment. The verbal reminder may be realized by automated voice. In addition, given different methods of delivery of a reminder notification (e.g., via facsimile, SMS, email, wireline telephone, etc.), server 28 may decide to utilize one method of delivery over another depending on the particular situation. For example, when the user's wireless phone is unresponsive as it is outside its home area or wireless phone service coverage, server 28 may instead send the reminder notification via SMS. To that end, database 20 contains the user's SMS and other contact information provided by the user.

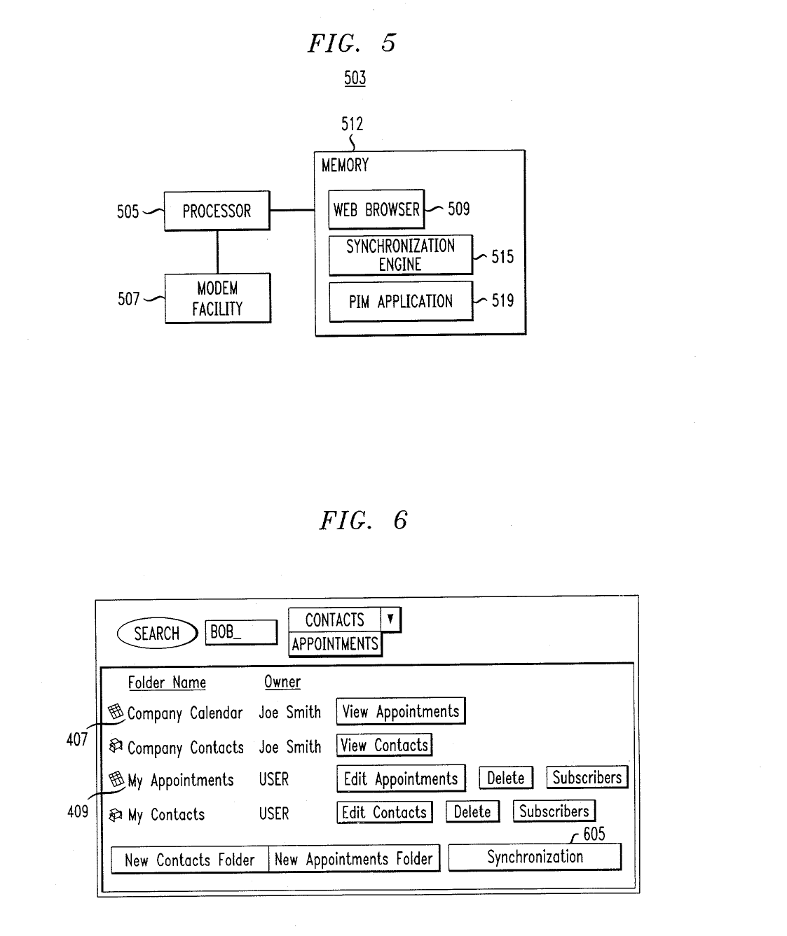

As mentioned before, the user may also directly access server 28 to set up one or more appointments folders in database 20, e.g., via the Internet to which server 28 is connected. By way of example, the user utilizes a computer, e.g., personal computer (PC) 503 in FIG. 5, which includes, among others, processor 505, modem facility 507 for establishing an Internet connection with server 28, and memory 512 in which web browser 509 is installed for navigating, e.g., through the aforementioned web pages to create, maintain and/or view the appointments folders. It will be appreciated that PC 503 may be connected to the Internet via other means such as a cable modem, network connection card, DSL line, etc. Server 28 presents to PC 503 through an established Internet connection a Home page illustrated in FIG. 6, which is similar to the Home GUI of FIG. 4 except that the Home page of FIG. 6 also includes option 605 for data synchronization.

In this instance, the user also utilizes PIM application 519, e.g., Microsoft Outlook, Outlook Express, Goldmine, Symantec Act!, Lotus Organizer, Lotus Notes, etc. to organize his/her appointments in one or more calendars. However, to effectively conduct day-to-day activities, the calendar data sources in one such PIM need to be synchronized from time to time with the appointments folders in database 20 corresponding thereto so that any changes in the PIM data sources are reflected in the corresponding folders, and vice versa. To that end, synchronization engine 515, also installed in PC 503, is used to perform the desirable synchronization function. In this illustrative embodiment, engine 515 is designed based on a commercially available Intellisync Connector SDK kit provided by Puma Technology, San Jose, Calif. Engine 515 may be downloaded from server 28 via the Internet and is configured according to PIM application 519 used. For example, in configuring engine 815, all of the appointment folders in database 20 associated with the user, e.g., folders 407 and 409, are identified. Thereafter by selecting Synchronization option 605 in FIG. 6, the user can cause the synchronization of the PIM calendar data sources with corresponding folders 407 and 409. Alternatively, the synchronization may be automated by programming engine 515 to synchronize the specified folders with the associated PIM data sources from time to time, provided that computer 503 is connected to server 28. For example, engine 515 may be programmed to perform unattended synchronizations at specified times, after computer 503 has been idle for a specified period, or when the user logs on/off computer 503. In addition, engine 515 may be programmed to suspend any automated synchronization while computer 503 is running on battery power.

However, a problem may arise when the user's PIM, e.g., PIM application 519, which typically is set to operate on a default time zone, synchronizes its PIM calendar with another system managing the user's appointment data, e.g., server 28. Specifically, let's say the user is based in California and the default time zone of the user's PIM is accordingly set to the Pacific time zone. When such a PIM user sets up an appointment to meet someone, say, in New York at 4 p.m. EST on April 30, knowing that he/she will physically be in New York at that time, the user enters the appointment time simply as “4 p.m” in the PIM calendar, ignoring the fact that the default time zone of the PIM is set to the Pacific time zone. In that case, recognizing that the default time zone of the user's PIM is the Pacific time zone, server 28 creates, as a result of the PIM data synchronization, an appointment record of the aforementioned meeting as a 4 p.m. PST meeting, as opposed to the actual 4 p.m. EST meeting. Thus, for example, based on such an erroneous appointment record, an operator in an information/call center would provide, to the user or others having access rights to the record, the incorrect appointment information, and may also incorrectly schedule events around the meeting for the user in providing personalized services; server 28 may also send an inaccurate reminder of such a meeting to the user, all of which are undesirable.

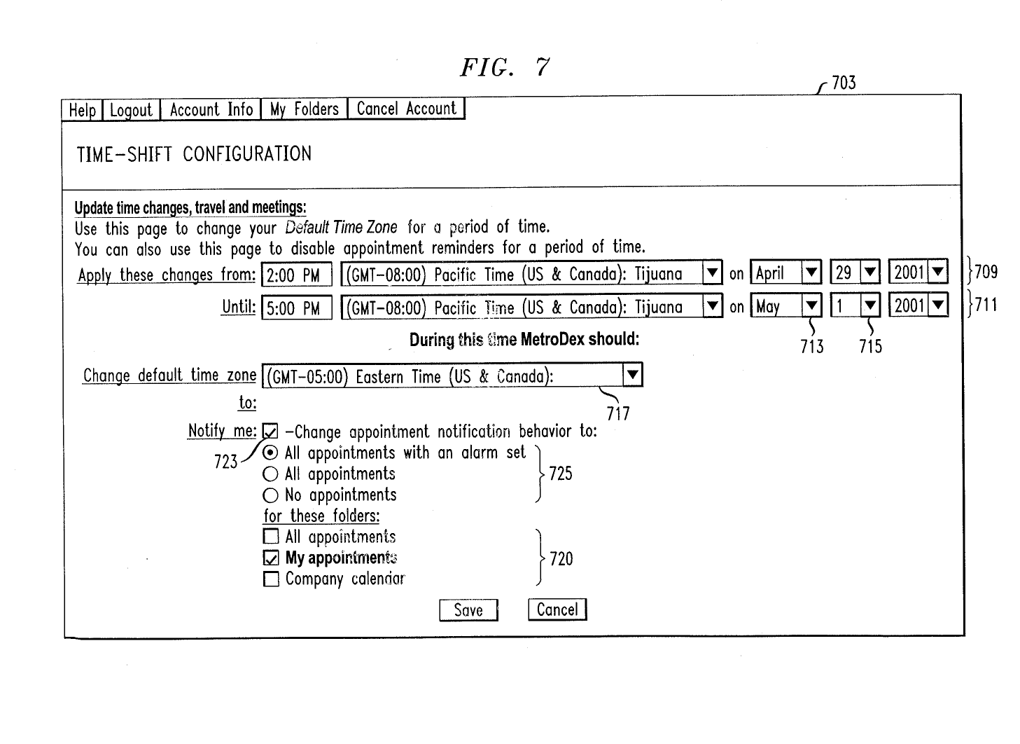

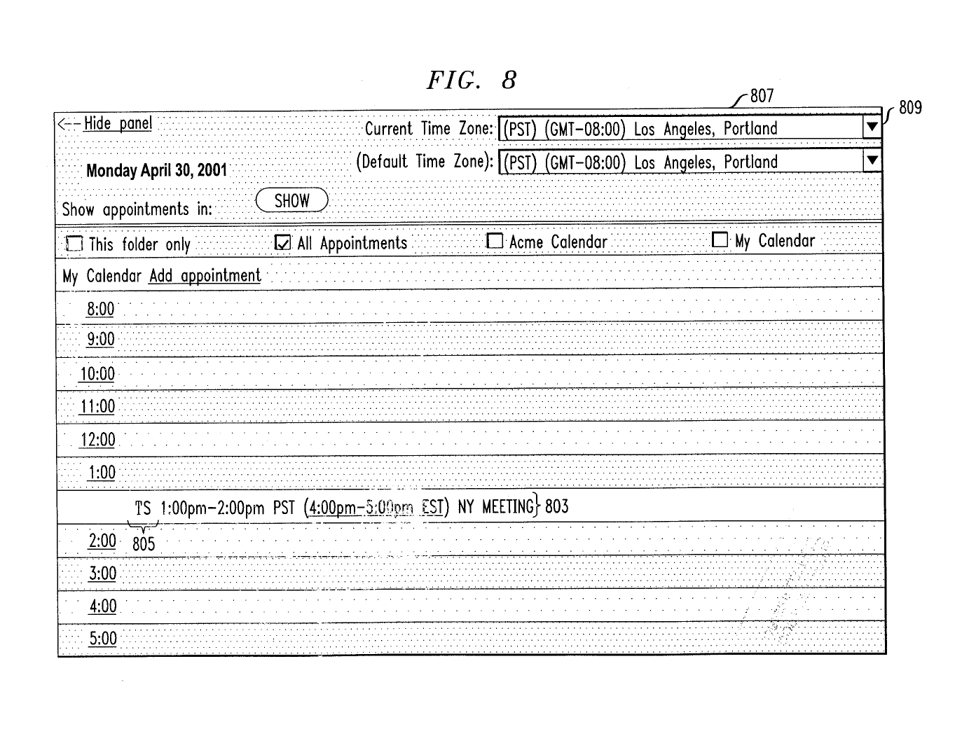

To solve the above-identified problem, rather than force the user to change his/her behavior, the user is allowed to specify to server 28 a certain time range, those appointments within which should be “time-shifted” from the default time zone to a different time zone, in accordance with the invention. After the user selects Synchronization option 605 in FIG. 6, the user's calendar data in PIM application 519 in a conventional manner is transmitted to server 28, and incorporated in the appropriate appointments folders in database. However, in accordance with the invention, server 28 in return presents to PC 503 a Time-Shift Configuration page, denoted 703 in FIG. 7, thereby prompting the user to specify any time range within which appointments in the folders need to be correctly time-shifted from the default time zone used in PIM application 519 to a specified time zone. In this instance, the user enters the start time and end time of the upcoming New York trip during which the times of the user's appointments are scheduled based on the Eastern time zone, rather than the default Pacific time zone. Accordingly, the user enters at row 709 on page 703 the start time of his/her New York stay, e.g., 2:00 p.m. Pacific time (GMT-08:00) on Apr. 29, 2001 in this instance. The user also enters at row 711 the end time thereof, e.g., 5:00 p.m. Pacific time (GMT-08:00) on May 1, 2001 in this instance. In addition, the user enters at field 717 the effective shifted time zone for the specified time range, e.g., the Eastern time (GMT-05:00) zone in this instance. For example, the entries at rows 709 and 711, and field 717 may be made using a conventional drop-down list function, such as function 713 for selecting a month or function 715 for selecting a day.

In accordance with an aspect of the invention, the user may also specify from list 720 the appointments folder(s), e.g., folder 407 and/or 409, in which the user's appointment records should be affected by such a temporary time-shift from the default Pacific time zone to the newly selected Eastern time zone. In addition, when Notify Me option 723 is selected, list 725 is presented from which an option may be selected by the user to make any change in the manner in which the user is notified about appointments during the specified time range. This selection may override the notification routine previously specified by the user.

Based on the information entered by the user on page 703, server 28 time-shifts any appointments in the specified folders within the specified time range from the default time zone to the different, specified time zone. Accordingly, the time-shifted appointments are indicated as such on the daily, weekly and monthly calendar view pages when they are retrieved by the user or operator from server 28. For example, the daily calendar view page from server 28 for Apr. 30, 2001 within the specified time range is illustrated in FIG. 8. The New York meeting appointment in question, denoted 803, is shown with both the correct appointment time according to the current time zone and that according to the shifted time zone in parenthesis. In this instance, the current time zone indicated in field 807 is set to be the Pacific time zone.

However, it should be noted that when a calendar view page is invoked by an operator, the current time zone is set to be the time zone of the location where the operator's information/call center is. However when a calendar view page is invoked by a user, the current time zone is the one set by the user.

For example, when the user is en route to New York for the aforementioned meeting, and stops, say, at Denver, Colo. for other business. While the user is in Denver which is in the Mountain time (GMT-7:00) zone, the user may prefer the New York meeting appointment to be shown on a calendar view page according to the Mountain time zone, rather than the Pacific time zone previously selected. In that case, the user may change the current time zone in field 807 to the Mountain time zone using drop-down list function 809. Accordingly, the time of appointment 803 in the Pacific time zone, i.e., 1:00 p.m.-2:00 p.m. PST, would be changed to the corresponding time in the Mountain time zone, i.e., 2:00 p.m.-3:00 p.m. MST.

It should also be noted that “TS” icon 805 to the left of appointment 803 helps provide the user or operator with an additional visual cue that appointment 803 is a time-shifted appointment.

If the user has indicated on page 703 that appointment alarm notification for a time-shifted appointment is required. The corresponding alarm time is accordingly adjusted in the following manner:

Adjusted Alarm Time in Default Time Zone=Meeting Time Entered by the User−Alarm Prealert Period+Default Time Zone GMT Offset−Shifted Time Zone GMT Offset. (1)

In this instance, the meeting time entered by the user is 4:00 p.m.; the alarm prealert period is 15 minutes, i.e., 0:15 hour; because the default time zone is the Pacific time zone, the corresponding GMT offset is −5:00 hours; and because the shifted time zone is the Eastern time zone, the corresponding GMT offset is −8:00 hours. As a result, according to expression (1), the time at which an alarm notification of the New York meeting appointment sent to the user is 12:45 p.m. Pacific time according to the default time zone (or 3:45 p.m. Eastern time according to the shifted time zone).

Thus, in the above time-shift approach, during PIM data synchronization, PIM calendar data by the user is initially accepted by server 28, subject to any corrections based on the user's input on Time-Shift Configuration page 703. However, in a second embodiment of the invention, a “time-zone qualifier” approach is employed where use of such a page to correct accepted PIM calendar data is obviated. In this second embodiment, the PIM calendar data, if necessary, is corrected by server 28 in the first instance when the data is synchronized into database 20.

In accordance with the time-zone qualifier approach, before an appointment is synchronized in from a PIM, e.g., application 519, the user may include a time-zone qualifier in the PIM appointment record to indicate to server 28 that a time zone correction of the appointment is necessary before its actual synchronization into database 20. For example, the time-zone qualifier may include a representation of the correct time zone in a predetermined field of the record. Alternatively, the qualifier may be incorporated in any fields of the record such as the subject field, location field, etc. However, in that case, priority may be accorded to different time-zone qualifiers which coexist in various fields of the record. In this instance, the qualifier in the subject field takes precedence over that in the location field, which takes precedence over that in the notes field, so on and so forth. In addition, a time-zone qualifier may take the form of any valid time zone abbreviation or verbose text in parenthesis, e.g., “( )” or “[]”. A translation table (not shown) is used in server 28 to translate a given time-zone qualifier to the corresponding time zone. For example, using this table, server 28 translates time-zone qualifiers such as “[PST],” “[US/Pacific],” “[Pacific Time],” “((GMT-08:00) pacific Time (US & Canada); Tijuana),” etc. to the Pacific time zone; and “(EDT),” “(Eastern),” “[GMT-05:00],” etc. to the Eastern time zone.

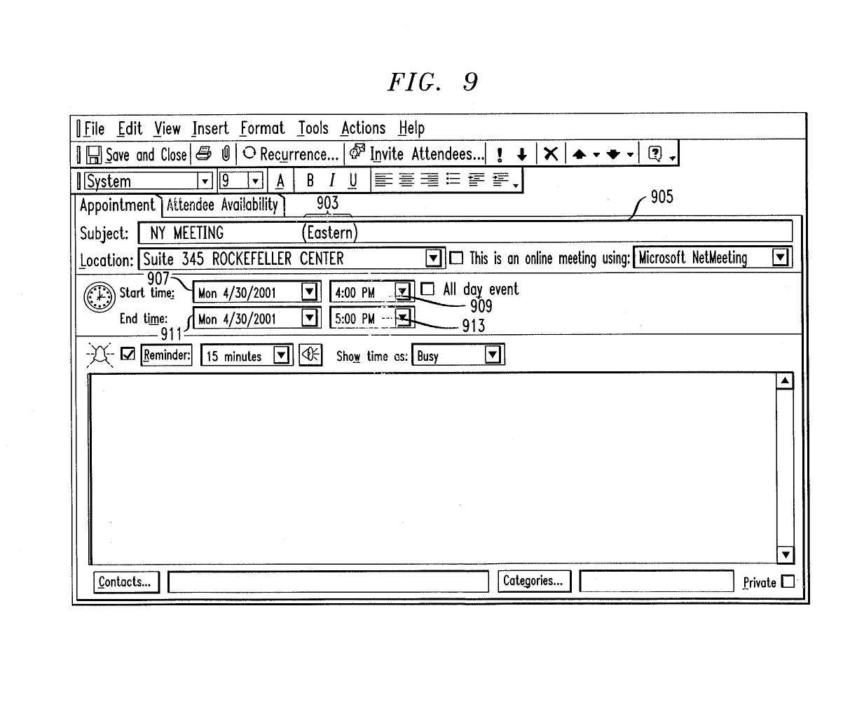

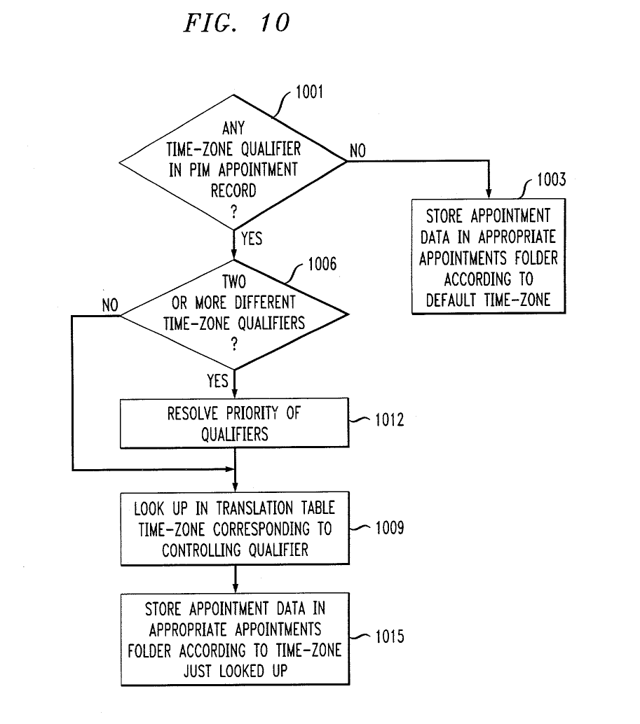

FIG. 9 illustrates a PIM appointment record in application 519 containing the aforementioned New York meeting appointment data. In this instance, time-zone qualifier 903, e.g., “(Eastern),” is incorporated in subject field 905 of the record.

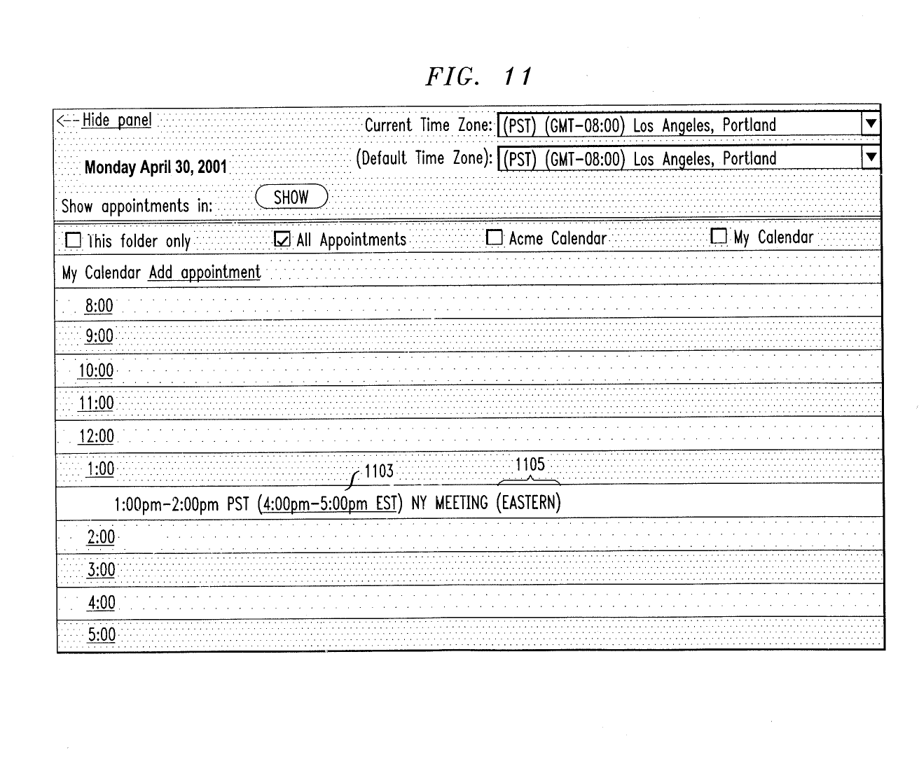

In general, instructed by a calendar data synchronization routine, server 28 identifies any time-zone qualifier in a PIM appointment record (e.g., qualifier 903 in the record of FIG. 9) to be synchronized, as indicated at step 1001 in FIG. 10. If no such qualifier is identified, server 28 at step 1003 stores in the appropriate appointments folder in database 20 the appointment data from the PIM record including the appointment time according to the PIM's default time zone, which is the Pacific time zone in this instance. Otherwise, server 28 at step 1006 determines whether two or more different time-zone qualifiers are identified. If not, the routine proceeds to step 1009 described below. Otherwise, if two or more different qualifiers are identified, server 28 resolves the priority of these qualifiers in accordance with a predetermined priority scheme, as indicated at step 1012. Server 28 at step 1009 looks up in the aforementioned translation table the time zone corresponding to the controlling qualifier, e.g., “(Eastern)” qualifier 903 in the record of FIG. 9. At step 1015, server 28 then stores in the appropriate appointments folder in database 20 the appointment data from the PIM record including the appointment time according to the time zone just looked up (e.g., the Eastern time zone), which when different from the default time zone overrides the same.

Thus, in this example, the Eastern time zone indicated by time-zone qualifier 903 in the PIM record of FIG. 9 overrides the default Pacific time zone. As a result, the appointment start time specified in fields 907 and 909, i.e., Mon Apr. 30, 2001 4:00 PM, is recognized by server 28 as being according to the Eastern time zone. The appointment end time specified in fields 911 and 913, i.e., Mon Apr. 30, 2001 5:00 PM, is recognized by server 28 as being according to the Eastern time zone as well. Thus, unlike the above time-shift approach where a time zone correction is performed on all appointments within a specified time range, the time-zone qualifier approach allows a time zone correction to be selectively performed on an appointment-by-appointment basis.

FIG. 11 illustrates a daily calendar view page of Apr. 30, 2001 in the second embodiment, which shows the New York meeting appointment, denoted 1103, from a user appointments folder after the PIM calendar data synchronization is performed. Similar to appointment 803 of FIG. 8, appointment 1103 is shown with both the correct appointment time according to the current time zone, i.e., the Pacific time zone, and that according to the qualified time zone in parenthesis, i.e., the Eastern time zone. The time-zone qualifier (denoted 1105) which echoes qualifier 903 applied by the user is also included in appointment 1103.

The foregoing merely illustrates the principles of the invention. It will thus be appreciated that those skilled in the art will be able to devise numerous other arrangements which embody the principles of the invention and are thus within its spirit and scope.

For example, in the disclosed embodiment, the direction of the calendar data synchronization illustratively is from a PIM to database 20. However, the invention equally applies to the data synchronization in the reverse direction, i.e., from database 20 to a PIM. In that case, server 28 may keep track of the corrected time zone in addition to the time zone supplied by the PIM, so that if an appointment in the database is synchronized back to the PIM, the appointment time would be “uncorrected.” For example, the above 4:00 p.m. EST New York meeting time when synchronized back to the PIM remains to be simply “4 p.m.” despite the fact that the default time zone used in the PIM is the Pacific time zone.

Finally, information/call center 100 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for sharing selected information in a data item in a first source with a second source, the first source operating on a selected time reference, the data item being associated with a time, the method comprising:
receiving a time range within which times associated with data items in the first source which would otherwise be considered according to the selected time reference should be considered according to a second time reference in the second source;
determining whether the time associated with the data item is within the time range; and
storing the selected information and the time associated with the data item in the second source, the associated time being considered according to the second time reference in the second source when it is determined that the associated time is within the time range.

2. The method of claim 1 wherein the selected time reference includes a time zone, and the second time reference includes another time zone.

3. The method of claim 1 wherein the data item concerns a time-sensitive event.

4. The method of claim 3 further comprising adjusting a time of sending an alert about the time-sensitive event when it is determined that the associated time is within the time range.

5. The method of claim 3 wherein the time sensitive event includes an appointment.

6. The method of claim 1 wherein the first source includes a personal information manager (PIM).

7. The method of claim 1 wherein the second source includes a database accessible through an information service.

8. The method of claim 7 wherein the information service is provided by an operator.

9. The method of claim 1 wherein the second source includes a database accessible through a communications connection.

10. The method of claim 9 wherein the communications connection includes an Internet connection.

11. The method of claim 9 wherein the communications connection includes a voice connection.

12. The method of claim 1 further comprising showing the associated time from the second source with an indicator indicating that the associated time is according to a time reference different than the selected time reference.

13. A method for sharing selected information in a data item in a first source with a second source, the first source operating on a selected time reference, the data item being associated with a time, the method comprising:
determining whether the data item includes at least one time-reference indicator;
identifying a second time reference based on one of the at least one time-reference indicator when it is determined that the data item includes at least one time-reference indicator; and
storing the selected information and the time associated with the data item in the second source, the associated time which would otherwise be considered according to the selected time reference being considered according to the second time reference in the second source after the second time reference is identified.

14. The method of claim 13 wherein the at least one time-reference indicator indicating a time zone.

15. The method of claim 14 wherein the at least one time-reference indicator includes an abbreviation of the time zone.

16. The method of claim 13 wherein the at least one time-reference indicator includes a plurality of time-reference indicators, the method further comprising selecting from the plurality of time-reference indicators a controlling time-reference indicator in accordance with a predetermined priority scheme, the controlling time-reference indicator indicating the second time reference.

17. The method of claim 16 wherein the predetermined priority scheme determines priority of each time-reference indicator based on a location of the time-reference indicator in the data item.

18. The method of claim 13 wherein the data item concerns a time-sensitive event.

19. The method of claim 18 further comprising adjusting a time of sending an alert about the time-sensitive event after the second time reference is identified.

20. The method of claim 18 wherein the time sensitive event includes an appointment.

21. The method of claim 13 wherein the first source includes a PIM.

22. The method of claim 13 wherein the second source includes a database accessible through an information service.

23. The method of claim 22 wherein the information service is provided by an operator.

24. The method of claim 13 wherein the second source includes a database accessible through a communications connection.

25. The method of claim 24 wherein the communications connection includes an Internet connection.

26. The method of claim 24 wherein the communications connection includes a voice connection.

27. The method of claim 13 further comprising showing the associated time from the second source with the time-reference indicator indicating the second time reference.

28. A system for sharing selected information in a data item in a first source with a second source, the first source operating on a selected time reference, the data item being associated with a time, the system comprising:
an interface for receiving a time range within which times associated with data items in the first source which would otherwise be considered according to the selected time reference should be considered according to a second time reference in the second source;
a processing unit for determining whether the time associated with the data item is within the time range; and
a database for storing the selected information and the time associated with the data item in the second source, the associated time being considered according to the second time reference in the second source when it is determined that the associated time is within the time range.

29. The system of claim 28 wherein the selected time reference includes a time zone, and the second time reference includes another time zone.

30. The system of claim 28 wherein the data item concerns a time-sensitive event.

31. The system of claim 30 wherein a time of sending an alert about the time-sensitive event is adjusted when it is determined that the associated time is within the time range.

32. The system of claim 30 wherein the time sensitive event includes an appointment.

33. The system of claim 28 wherein the first source includes a PIM.

34. The system of claim 28 wherein the database is accessible through an information service.

35. The system of claim 34 wherein the information service is provided by an operator.

36. The system of claim 28 wherein the database is accessible through a communications connection.

37. The system of claim 36 wherein the communications connection includes an Internet connection.

38. The system of claim 36 wherein the communications connection includes a voice connection.

39. The system of claim 28 wherein the associated time from the database is shown with an indicator indicating that the associated time is according to a time reference different than the selected time reference.

40. A system for sharing selected information in a data item in a first source with a second source, the first source operating on a selected time reference, the data item being associated with a time, the system comprising:
a processing unit for determining whether the data item includes at least one time-reference indicator, a second time reference being identified based on one of the at least one time-reference indicator when it is determined that the data item includes at least one time-reference indicator; and
a database for storing the selected information and the time associated with the data item in the second source, the associated time which would otherwise be considered according to the selected time reference being considered according to the second time reference in the second source after the second time reference is identified.

41. The system of claim 40 wherein the at least one time-reference indicator indicating a time zone.

42. The system of claim 41 wherein the at least one time-reference indicator includes an abbreviation of the time zone.

43. The system of claim 40 wherein the at least one time-reference indicator includes a plurality of time-reference indicators, the method further comprising selecting from the plurality of time-reference indicators a controlling time-reference indicator in accordance with a predetermined priority scheme, the controlling time-reference indicator indicating the second time reference.

44. The system of claim 43 wherein the predetermined priority scheme determines priority of each time-reference indicator based on a location of the time-reference indicator in the data item.

45. The system of claim 40 wherein the data item concerns a time-sensitive event.

46. The system of claim 45 wherein a time of sending an alert about the time-sensitive event is adjusted after the second time reference is identified.

47. The system of claim 45 wherein the time sensitive event includes an appointment.

48. The system of claim 40 wherein the first source includes a PIM.

49. The system of claim 40 wherein the database is accessible through an information service.

50. The system of claim 49 wherein the information service is provided by an operator.

51. The system of claim 40 wherein the database is accessible through a communications connection.

52. The system of claim 51 wherein the communications connection includes an Internet connection.

53. The system of claim 51 wherein the communications connection includes a voice connection.

54. The system of claim 40 wherein the associated time from the database is shown with the time-reference indicator indicating the second time reference.
